(19) United States
(12) Patent Application Publication
(10) Pub. No.: US 2011/0102577 A1
(43) Pub. Date: May 5, 2011

(54) OPTICAL DETECTION DEVICE AND METHOD FOR DETECTING SURFACES OF COMPONENTS

(75) Inventors: Uladimir Prakapenka, Roding (DE); Franz Brandl, Traitsching (DE)

(73) Assignee: Muhlbauer AG, Roding (DE)

(21) Appl. No.: 12/937,347

(22) PCT Filed: Mar. 11, 2009
(86) PCT No.: PCT/EP09/52823

§ 371 Date: Dec. 20, 2010

(30) Foreign Application Priority Data
Apr. 12, 2008 (DE) 10 2008 018 586.8

(51) Int. Cl. H04N 7/18

(52) U.S. Cl. 348/128; 348/E07.085

(57) ABSTRACT

The invention relates to an optical detection device for the detection of at least one surface (11a) of at least one component (11), the component (11) being capable of being transported from a first to a second workstation (2, 3) by means of a retaining element (15), and a camera instrument (18) being directed onto a first surface (11a) of the component (11), with at least one light-source (12) which transmits first light-beams (25, 26) in the short-wave range to the first surface (11a), with at least one second light-source (13a, 13b) which transmits second light-beams (29, 30) in the long-wave range to at least one second surface (11b, 11c) of the component (11) which is oriented differently in relation to the first surface (11a), and with the camera instrument which receives the first and second light-beams (27, 33, 34) reflected on the surfaces (11a-c) for the purpose of generating an image (37) of the surfaces.

### CROSS-REFERENCE TO RELATED APPLICATIONS

This application is a National Stage of International Application No. PCT/EP2009/052823, filed Mar. 11, 2009, which claims the priority of German Patent Application Serial No. DE 10 2008 018 586.8, filed Apr. 12, 2008.

### DESCRIPTION

The invention relates to an optical detection device and to a method for the detection of at least one surface of at least one component, the component being capable of being transported, independently of the preceding process steps, from a first to a second workstation by means of a retaining element, and a camera instrument being directed onto the surfaces of the component, in accordance with the precharacterising portions of claims 1 and 10.

In so-called pick-and-place machines, components—in particular electronic components such as a chip or a die, for example—are conventionally picked up by a retaining element—such as a gripping element, for example—in a first workstation and are subsequently set down on or in a carrier material in a second workstation. Before the component is set down, ordinarily an inspection of the component takes place in such a manner that a surface of the component is recorded pictorially by a camera instrument, in order by this means to generate a surface image for examination purposes.

Gripping elements of such a type retain the component on their underside during transportation and during the inspection or detection of the lower surface of the component which is to be carried out. By this means, although the camera instrument arranged beneath the component in spaced manner is able to implement an image-recording of the bottom surface of the component, the laterally arranged surfaces of a component—which, for example, takes rectangular or square form in its basal surface—are not detected by the camera instrument. Similarly, it is known that by means of elaborately constructed inspection facilities the lateral surfaces of the component which is provided with a rectangular basal surface and which takes the form of a right parallelepiped can indeed additionally be detected pictorially; for this purpose, however, on the one hand an intermediate stop during the transport path for the purpose of recording the various surfaces of the component and, on the other hand, either a plurality of camera instruments or an elaborately constructed mirror system are necessary. This disadvantageously results in a lower throughput of pick-and-place machines of such a type, by reason of the intermediate stop and the production of elaborate inspection facilities.

The object of the invention is therefore to make available an optical detection system for the detection of surfaces of at least one component within a pick-and-place machine, said system enabling a rapid optical detection of a plurality of differently oriented surfaces of the component, being simple in structure and capable of being produced inexpensively.

This object is achieved, in terms of a device, in accordance with the features of claim 1 and, in terms of a process, in accordance with the features of claim 10.

An essential point of the invention consists in the fact that in the case of an optical detection device for the detection of at least one surface of at least one component, in particular an electronic component, which is capable of being transported from a first to a second workstation by means of a retaining element, whereby a camera instrument is directed onto a first surface of the component, use is made of at least one first light-source, which transmits first light-beams in the short-wave range to the first surface, at least one second light-source, which transmits second light-beams in the long-wave range to at least one second surface of the component, and the camera instrument for receiving the first and second light-beams reflected on the surfaces. In this connection the at least one second surface is oriented differently in relation to the at least one first surface, as is the case, for example, with components taking the form of right parallelepipeds with an underside and with a total of four lateral surfaces.

Of course, in the case of the second surfaces it may also be a question of a number of surfaces other than four if a different component shape is present.

Through the use of two light-sources and the light-beams that emit differing wavelengths, it is advantageously made possible that both the bottom surface of the component, which may be a die, and the further surfaces arranged to be laterally peripheral (e.g. front sides of the component) can be recorded pictorially by a common camera instrument, since a light-source system or illuminating system of such a type permits the mutual coordination, in straightforward manner, of various focal planes of the first surface, on the one hand, and of the at least one second surface, on the other hand. If, instead of this, use were to be made of a common light-source with a common wavelength of the emitted light-beams for the purpose of illuminating all the surfaces of the component, differing focal planes would arise as a result of this in the region of the camera instrument, which render more difficult a sharp image-recording of all the surfaces on a sensor element—which, for example, is formed in planar manner—in the region of the camera instrument. On the other hand, through the use of a light-source that operates in the short-wave range and that is responsible for the illumination of the surfaces of the component arranged on the underside, the focal plane resulting from this for sharp imaging of this first surface can be more easily coordinated with one of the focal planes of the second light-beams of the at least one second light-source which operates in the long-wave range. This is because within a route segment in the region of the camera instrument there are situated a plurality of focal planes of the reflected first light-beams, whereas only a few focal planes of the second light-beams in the long-wave range are present in this route segment.

In addition, by virtue of the present invention it advantageously turns out that only one camera instrument has to be set up, not several camera instruments.

A further significant advantage of the invention consists in the fact that no intermediate stop is required during the transportation of the component from a first to a second workstation, in order—as conventionally hitherto—to position the component in a detection region or inspection region provided for this purpose, preferentially in the upward and downward directions, should one wish to detect pictorially both the bottom surface of the component and the peripheral lateral surfaces of the component which, for example, takes the form of a right parallelepiped.

According to a preferred embodiment, at least one at least partly reflecting beam-splitter plate is provided, on which the light-beams of the first light-source are capable of being deflected before reaching the first surface, that is to say, the surface of the component that is arranged on the underside. Consequently the arrangement of the first light-source is possible outside a common optical axis on which the camera instrument, the component and the beam-splitter plate are situated.

The beam-splitter plate arranged in the optical axis is advantageously designed in one surface in such a manner that it reflects the light-beams firstly emitted from the first light-source, in order to guide said light-beams onto the bottom first surface of the component, but does not reflect the first light-beams reflected on the bottom first surface of the component and consequently coming back, but rather transfers said light-beams in light-transmitting manner, in order to cause them subsequently to be incident on the camera instrument arranged beneath the beam-splitter plate.

In the region between the beam-splitter plate and the component the first light-beams run, both on their forward path to the component and on their return path from the component, to the camera instrument parallel to the optical axis or on the latter.

Preferentially the second light-beams of the at least one second light-source are directed onto the at least one second surface with an incidence angle relative to the surface plane and are reflected from the second surface with a reflection angle relative to the surface plane of the second surface. The second light-beams reflected from the second surface or second surfaces are guided onto a reflecting element which is fitted, preferentially above the component, to the retaining element to which the component is fastened, reflected again from this, in order subsequently to guide these onto the camera instrument. In this connection, the second light-beams reflected for the second time, just like the first light-beams on their return path, are transferred though the beam-splitter plate and guided onto the camera instrument arranged below or to the side of the beam-splitter plate. The camera instrument may also exhibit any other position in relation to the beam-splitter plate.

The camera instrument exhibits at least one sensor, which is preferentially formed in planar manner, for detecting the reflected light-beams and for generating at least one image of the surfaces, the sensor being able to retransmit the detected image data to a display instrument electronically, where appropriate with electronic image-data processing which has taken place previously for the purpose of improving the sharpness of the imaged surfaces.

The reflecting element exhibits at least one, preferentially two or four, reflecting faces which are inclined by an angle in relation to the optical axis, in order to direct the incident light-beams, which have previously been reflected on the peripheral lateral second surfaces of the component, in the reflected state onto the face of the sensor of the camera instrument, taking account of a corresponding spacing from the other imaged surfaces.

Further advantageous embodiments result from the dependent claims.

Advantages and efficacy can be inferred in the following description. Shown are:

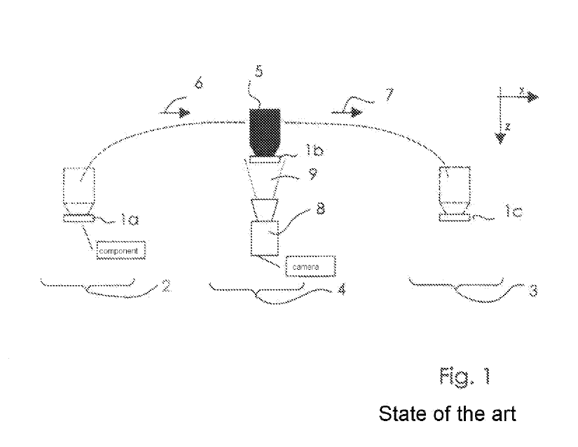

FIG. 1 in a schematic representation, a pick-and-place machine with an optical detection device according to the state of the art;

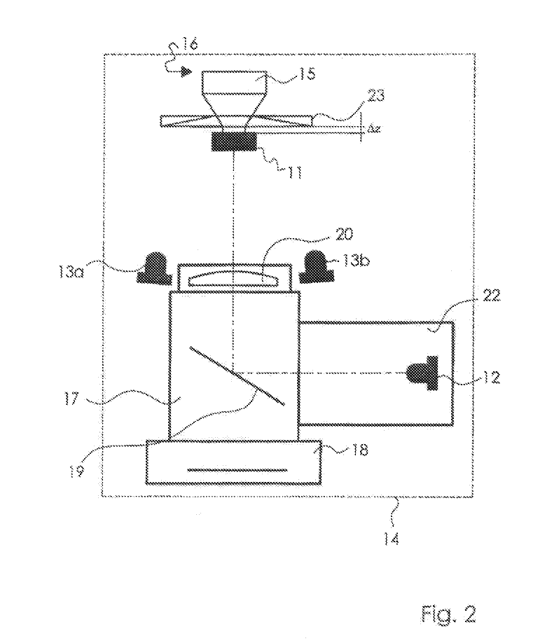

FIG. 2 an optical detection device according to an embodiment of the invention within a pick-and-place machine, in schematic representation without light-beam paths drawn in;

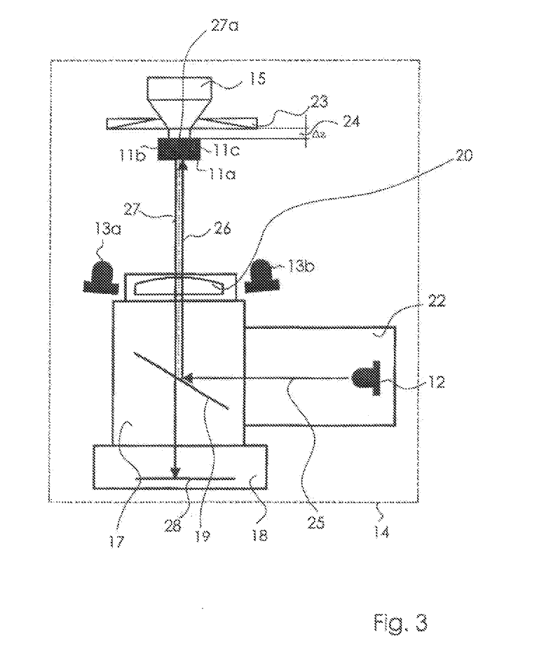

FIG. 3 in a schematic representation, the optical detection device reproduced in FIG. 2, with beam path drawn in of first light-beams of a first light-source;

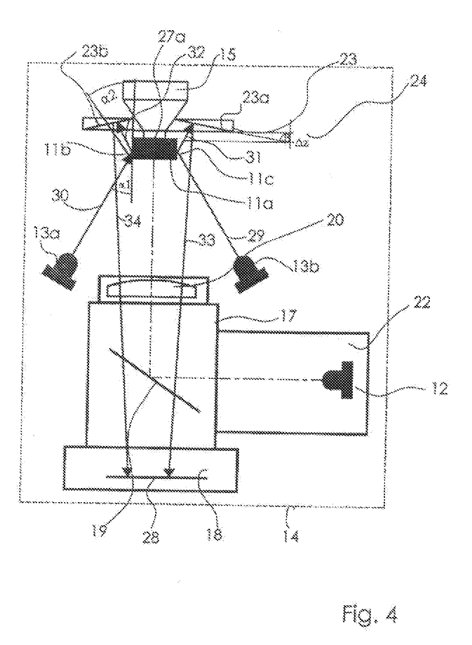

FIG. 4 the optical detection device shown in FIG. 2 with beam path drawn in of second light-beams of a second light-source, and

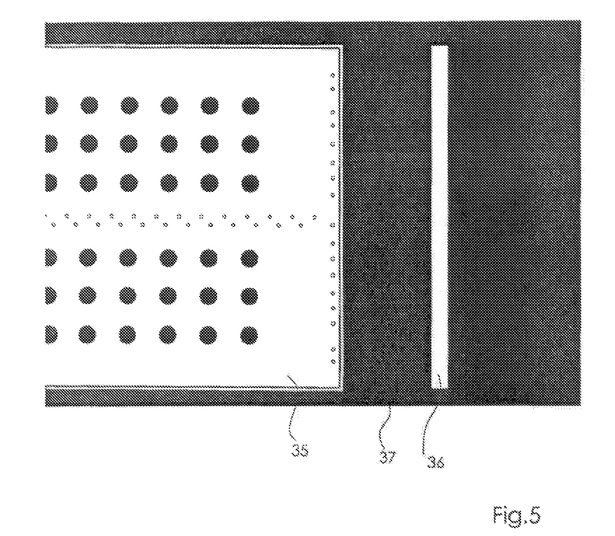

FIG. 5 a reproduction of an image of surfaces of an electronic component, recorded by the optical detection device according to the invention.

In FIG. 1 a pick-and-place machine with an optical detection device according to the state of the art is reproduced in a schematic representation. From this representation it can be inferred that an electronic component 1a—which may be, for example, a chip that takes the form of a right parallelepiped—is being transported from a workstation 2, in which it is picked up, to a workstation 3, in which it is set down. The electronic component is to be set down in workstation 3 is being transported between the first and second workstations 2, 3 by means of a retaining element or gripper 5 and is passing through a detection region or inspection region 4. The transport path is represented by the arrows 6, 7.

In the detection region 4 a camera instrument 8 is arranged which in conventional manner carries out a recording of a surface, arranged on the underside, of the electronic component 1b for the purpose of generating an image, as reproduced by reference symbol 9.

In FIG. 2 an optical detection device for a pick-and-place machine according to an embodiment of the invention is reproduced. In the optical detection device 14 an electronic component 11, a first light-source 12 and also second light-sources 13a and 13b are arranged.

The first light-source 12 emits light-beams in the short-wave range, whereas the second light-sources 13a and 13b emit light-beams in the long-wave range.

A retaining element 15 retains the electronic component on the upper side, for example by means of application of a vacuum.

The direction of transport of the electronic component during the image-recordings to be carried out is represented by the arrow 16, in which connection a standstill of the electronic component 11 and consequently of the retaining element 15 during image-recording is similarly conceivable. In the case of a standstill, the electronic component is stopped above a camera instrument, and several image-recordings are carried out, without—similarly as in the case of transportation without intermediate stop—a movement of the retaining element 15 with the electronic component in the z-direction—that is to say, in the upward and downward directions—being necessary for this purpose.

Within an objective 17, which is arranged at the top in the actual camera instrument 18, a beam-splitter plate 19 is arranged which, depending on the incidence direction of the light-beams, can function in both reflecting and light-transmitting manner.

A lens 20 serves for focusing the light-beams.

In FIG. 3 the optical detection device according to the embodiment of the invention is represented with a beam path of light-beams of the first light-source 12.

Arranged above the electronic component 11 with the first surface 11a and the second surfaces 11b, 11c is a reflecting element 23 which is spaced in relation to the electronic component 11 with a spacing 24.

The first light-source 12 emits light-beams 25. The first light-beams 25 impinge on the beam-splitter plate 19 which with this incidence direction has a reflecting effect and reflects the light-beams in such a manner that they are deflected onto the electronic component in accordance with reference symbol 26. The reflected light-beams 26 subsequently impinge on the bottom surface 11a of the electronic component 11 and are reflected there by 180°, since they arrive orthogonal to the surface plane of the surface 11a, as reproduced by reference symbol 27.

The first light-beams 27 reflected on the surface 11a are subsequently incident from a further incidence direction on the beam-splitter plate 19, which may also be a mirror which acts in light-transmitting manner for the incidence direction by virtue of an appropriate design of its surface.

The reflected first light-beams 27 in the short-wave wavelength range then impinge on a sensor 28 which is preferentially formed in planar manner and which enables a detection of the incident light-beams and consequently a reproduction of the surface 11a of the electronic component.

In FIG. 4 the optical detection device according to FIG. 2 and FIG. 3 is shown in a further schematic representation, in this representation the beam path being represented of second light-beams which emanate from the second light-sources 13a and 13b.

The second light-beams 29, 30 are emitted from the second light-sources 13a and 13b, which are oriented appropriately in relation to the lateral surfaces 11b and 11c, and impinge on the lateral surfaces 11b and 11c with an incidence angle α₁. Additionally, the front and rear lateral surfaces can be illuminated with further second light-sources or with the same second light-sources. However, this is not reproduced in this representation.

The light-beams 29, 30 which are incident on the surface with an incidence angle α₁ are reflected on these surfaces 11b and 11c and leave the surface in the reflected state with a reflection angle α₂. The second light-beams 31, 32 reflected on the surface now impinge on a reflecting face 23a, 23b of the reflecting element 23 which is fastened to the retaining element 15. Subsequently a further reflection of these second light-beams 31, 32 on the reflecting face 23a, 23b takes place in such a manner that the light-beams 33, 34 reflected thereon are guided onto the sensor 28. Previously, these reflected second light-beams 33, 34 similarly pass through the beam-splitter plate which for this incidence direction is designed to be light-transmitting.

The reflecting faces 23a and 23b are oriented, in coordination with the desired common focal planes of the first and second light-beams, into the region of the planar sensor 28 by an angle β in relation to the optical axis 27a on which the retaining element 15, the electronic component 11, the lens 20, the mirror 19 and the sensor 28 are located. Similarly, depending on the desired common focal planes, a spacing 24 which exists between the reflecting element 23 and the electronic component 11 is adjusted.

In FIG. 5 an image such as can be obtained by means of the sensor 28 by virtue of the incident reflected first and second light-beams is represented in exemplary manner. This image 37 includes the first surface 11a, represented as reference symbol 35, and one of the second surfaces 11b, 11c, as represented by reference numeral 36. From this representation it can be clearly inferred that the image-recordings exhibit the requisite sharpness in order to recognise, for example, bumps or terminal pads on the surfaces 11a, 11b and 11c of the electronic component, which may be a chip or a die.

All the features disclosed in the application documents are claimed as essential for the invention to the extent that they are novel, individually or in combination, in relation to the state of the art.

### LIST OF REFERENCE SYMBOLS

1a, 1b, 1c is component
2 first workstation
3 second workstation
4 detection station
5 retaining element
6, 7 directions of transport
8 camera instrument
9 recording region
11 electronic component
11a first surface
11b, c second surfaces
12 first light-source
13a, 13b second light-sources
14 detection device
15 retaining element
16 direction of transport
17 objective instrument
18 camera instrument
19 beam-splitter plate
20 lens
22 further objective part
23 reflecting element
23a, 23b reflecting faces
24 spacing
25 first light-beam
26 reflected first light-beam
27 reflected first light-beam
27a optical axis
28 sensor
29, 30 second light-beams
31, 32 reflected light-beams
33, 34 reflected light-beams
35 image-recording of the first surface
36 image-recording of the second surface
37 image

1. Optical detection device for the detection of at least one surface of at least one component, the component being capable of being transported from a first workstation to a second workstation by means of a retaining element, and a camera instrument being directed onto a first surface of the component, said device comprising:
a first light-source which transmits first light-beams in the short-wave range to the first surface, and
a second light-source which transmits second light-beams in the long-wave range to at least one second surface of the component which is oriented differently in relation to the first surface,
wherein the camera instrument which receives the first and second light-beams reflected on the surfaces for the purpose of generating an image of the surfaces.

2. Optical detection device according to claim 1, further comprising:
at least one at least partly reflecting beam-splitter plate, on which the first light-beams of the first light-source are capable of being deflected before reaching the first surface.

3. Optical detection device according to claim 2, wherein
the component, the beam-splitter plate and the camera instrument are arranged on a common optical axis, on or parallel to which run the first light-beams reflected on the surfaces of the component.

4. Optical detection device according to claim 1, wherein
the second light-beams of the at least one second light-source are directed onto the at least one second surface with an incidence angle relative to the surface plane and are reflected from the second surface with a reflection angle relative to the surface plane of the second surface.

5. Optical detection device according to claim 3, wherein
a reflecting element, fitted to the retaining element, for reflecting the second light-beams reflected on the second surface, in order to guide said light-beams onto the camera instrument.

6. Optical detection device according to claim 4, wherein
the beam-splitter plate is designed in such a manner that it is reflecting for the first light-beams incident from a first direction and transmitting for the first light-beams incident from a second direction and reflected on the first surface and also for the second light-beams reflected on the reflecting element.

7. Optical detection device according to claim 1, wherein
the camera instrument includes at least one sensor for detecting the reflected light-beams and for generating at least one image of the surfaces.

8. Optical detection device according to claim 2, wherein
at least one lens element is arranged between the beam-splitter plate and the component in the beam path of the reflected light-beams.

9. Optical detection device according to claim 4, wherein
the reflecting element exhibits at least one reflecting face which is inclined by an angle in relation to the optical axis.

10. Method for the optical detection of at least one surface of at least one component, the component being transported from a first to a second workstation by means of a retaining element, and a camera instrument being directed onto a first surface of the component, comprising:
at least one light-source transmits first light-beams in the short-wave range to the first surface, and at least one second light-source transmits second light-beams in the long-wave range to at least one second surface of the component which is oriented differently in relation to the first surface, and the camera instrument receives the first and second light-beams reflected on the surfaces for the purpose of generating an image of the surfaces.
